(19) United States
(12) Patent Application Publication
(10) Pub. No.: US 2010/0021065 A1
(43) Pub. Date: Jan. 28, 2010

(54) MULTIPLE IMAGE REGISTRATION APPARATUS AND METHOD

(76) Inventor: Alexander Sibiryakov, Surrey (GB)

Correspondence Address: BIRCH STEWART KOLASCH & BIRCH, PO BOX 747, FALLS CHURCH, VA, 22040-0747, US

(21) Appl. No.: 12/520,271

(22) PCT Filed: Dec. 20, 2007
(86) PCT No.: PCT/GB07/04907

§ 371 Date: Jun. 19, 2009

(30) Foreign Application Priority Data
Dec. 20, 2006 (GB) 0625455.1
Aug. 24, 2007 (EP) 07253363.1

(51) Int. Cl. G06K 9/46

(52) U.S. Cl. 382/190

(57) ABSTRACT

There is described a method of processing a plurality of images to determine one or more groups of images with each group of images forming a panorama. The method comprises identifying distinctive features in each image, comparing a distinctive feature in one image with distinctive features in other images to identify possible matching features, and processing said possible matches to determine said one or more groups of images. When comparing distinctive features, a distinctive feature in one image is only compared with a subset of the distinctive features in the other images which satisfy one or more predefined criteria. The criteria could involve the similarity of the images, or alternatively whether or not a decision on registration has already been made for the pair of images concerned, hi this way, the number of feature comparisons is reduced.

This invention relates to a method of processing a set of images to identify groups of images which can be merged to form a panorama, and to generating panorama data corresponding to a group of images.

A method of panorama recognition is discussed by Lowe and Brown in the article “Recognising Panoramas” in the Proceedings of the 9^{th} International Conference on Computer Vision, pp 1218-1225, Nice, France, October 2003. The method employed by Lowe and Brown is based on fast matching of scale invariant features (SIFT), robust estimation by Random Sample Consensus (RANSAC), bundle adjustment and multi-band image blending. In particular, image descriptors for all interest points are compared, and then identifying matches through nearest-neighbour searches in descriptor space. A probabilistic image match verification is then performed which compares the probabilities that the set of matched features resulted from a correct image match or from a false image match. This leads to a simple condition on the number of inliers and outliers in the area of overlap between the images, which allows the algorithm to reject false image matches in an effective manner.

The method of Lowe and Brown avoids quadratic-complexity problem of exhaustive feature matching by using high-dimensional feature space. While being efficient, this method has some drawbacks, in particular:

full sets of image descriptors are required to be extracted from images resulting in large memory and computation time consumption;

fast nearest-neighbour search becomes ineffective in high-dimensional space (usually 128-dimensional in the above method), and different approximated search methods are applied resulting in frequent mismatches.

Therefore, it is essential to design a method that reduces a quadratic complexity of feature matching and uses only low-dimensional criteria to establish correspondent features.

EP-A-1736928 discusses using a cluster-based approach for making decisions about image registration. The features from a first image are iteratively selected and the best matches with the features of a second image are computed. For these best matches, local rotation and scale transformation parameters between image regions centred at the feature points are estimated and a rotation-scale accumulator is updated by incrementing the element corresponding to the estimated transformation parameters. All feature matches contributing to the highest peak in the rotation-scale accumulator are then extracted and processed by RANSAC to check for global consistency. If the number of RANSAC inliers is sufficient, the image pair is considered as registered and iterations stop.

The method discussed in EP-A-1736928 has some drawbacks. In particular:

a large number of feature matches for non-matching image pairs must be computed before a decision on non-registration is made;

after the first few iterations, noisy clusters can be larger than the cluster of true matches, and processing noisy clusters with RANSAC can result in false decisions on registration;

even if the true cluster is selected correctly and the number of RANSAC inliers is high, the correctly matched interest points can be grouped in one part of the image, resulting in low registration accuracy; and

the highest peak of the accumulator does not always indicate the cluster with true matches, because the false matches also contribute to the peak's height value.

Graph structure is often used to represent pairwise image registrations within a set of images, see for example “Image Mosaicing and Super-Resolution” by D. Capel, PhD thesis, Dept of Eng. Science, univ. of Oxford, 2001 and “Robust video mosaicing through topology inference and local to global alignment” by Sawhney et al in Proc. European Conference on Computer Vision and Image Understanding, No. 2, Vol. 93, pp 175-194, 2004. A registration graph is employed in which images are represented by graph nodes and their two-view relations (feature correspondences, homography) are represented as graph edges. Transitive closure of the graph makes it possible to identify image relations that have not been explicitly established by the image registration algorithm. For example, if an image pair (A, B) is registered and there exists a path between B and C in the registration graph, the registration (or decision on non-registration) of A and C can be obtained using a sequence of homographies determined by the optimal path between A and C. If images A and C overlap to a high degree, registration can be performed using a fast homography-guided algorithm using features from the area of overlap.

In many previous approaches, the registration graph is initialised by pairwise registration of consecutive images or video frames, thus assuming that the image order is determined. If an adjacency matrix represents the graph, such initialisation corresponds to filling the matrix elements located just above the main diagonal. When this initialisation is performed, the next step of transitive closure corresponds to filling the elements in the next diagonal (above previously filled diagonal) and the process is repeated while an overlap between unregistered images can be found. Such a deterministic algorithm is not applicable in the case of unordered images, because the graph cannot be initialised with pairwise registrations.

An object of the present invention is to reduce the number of features in a set of images which have to be compared in order to identify groups of images which each correspond to a panorama.

According to an aspect of the invention, there is provided a method of processing a plurality of images to determine one or more groups of images with each group of images forming a panorama, the method comprising identifying distinctive features in each image; comparing a distinctive feature in one image with distinctive features in other images to identify possible matching features; and processing said possible matches to determine said one or more groups of images. When comparing a distinctive feature from one image with distinctive features in other images, only those distinctive features in the other images which a predefined criterion are considered. In this way, the amount of processing required is reduced.

Preferably, feature strengths are calculated for the distinctive features, and only features with similar feature strengths are compared. The feature strengths may be calculated by processing the image data using an interest point detector which generates an interest value for each point in the image, identifying local maxima as interest points, and then normalising the values of the local maxima to generate feature strengths. Preferably, a logarithmic normalisation takes place.

Preferably, the number of feature comparisons is further compared by iteratively performing a probabilistic analysis of the results of previous feature comparisons, and if rejecting image pair matchings if the probabilistic analysis indicates that a match is statistically improbable.

The number of feature matchings can further be reduced by iteratively performing transitive graph closure on the registration graph. In this way, overlapping images identified by the transitive closure operation can be registered, and/or non-overlapping images can be rejected.

Various exemplary embodiments of the invention will now be described with reference to the attached figures in which:

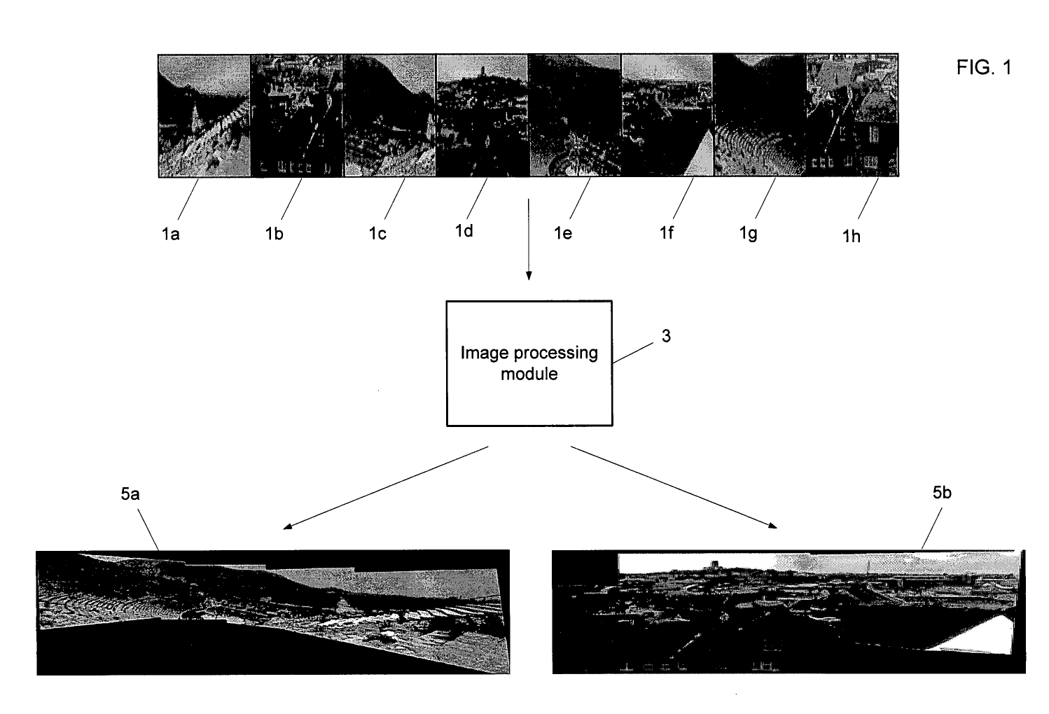

FIG. 1 schematically represents a first embodiment of the invention;

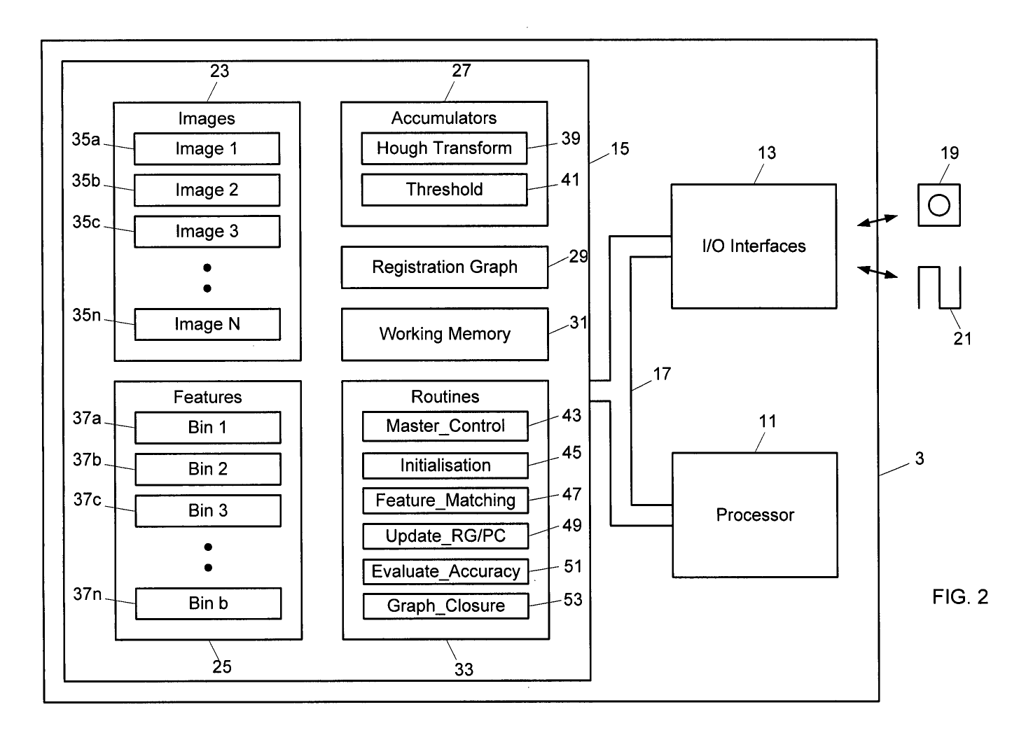

FIG. 2 schematically shows the main components of an image processing module illustrated in FIG. 1;

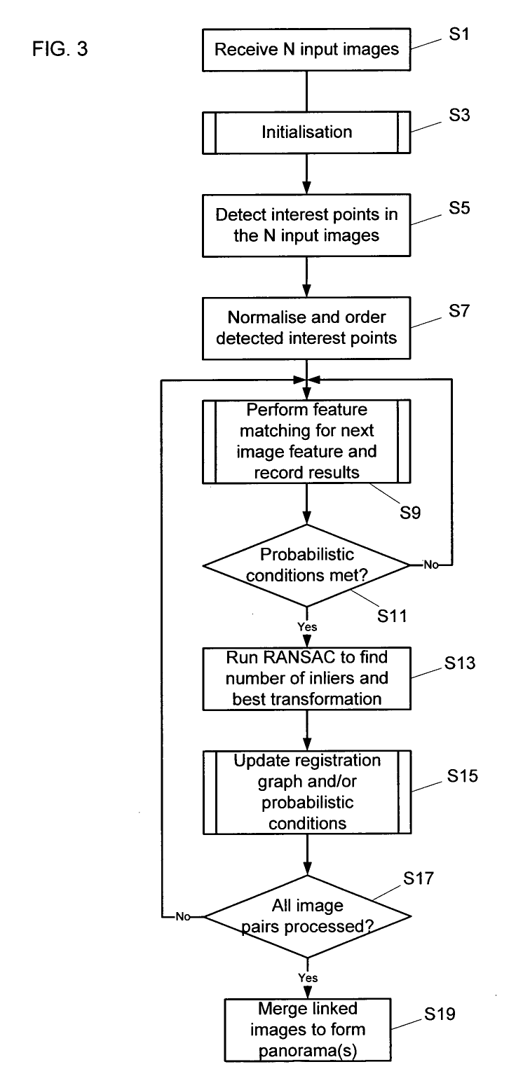

FIG. 3 is a flow chart showing an overview of the processing operations performed by the image processing module illustrated in FIG. 2;

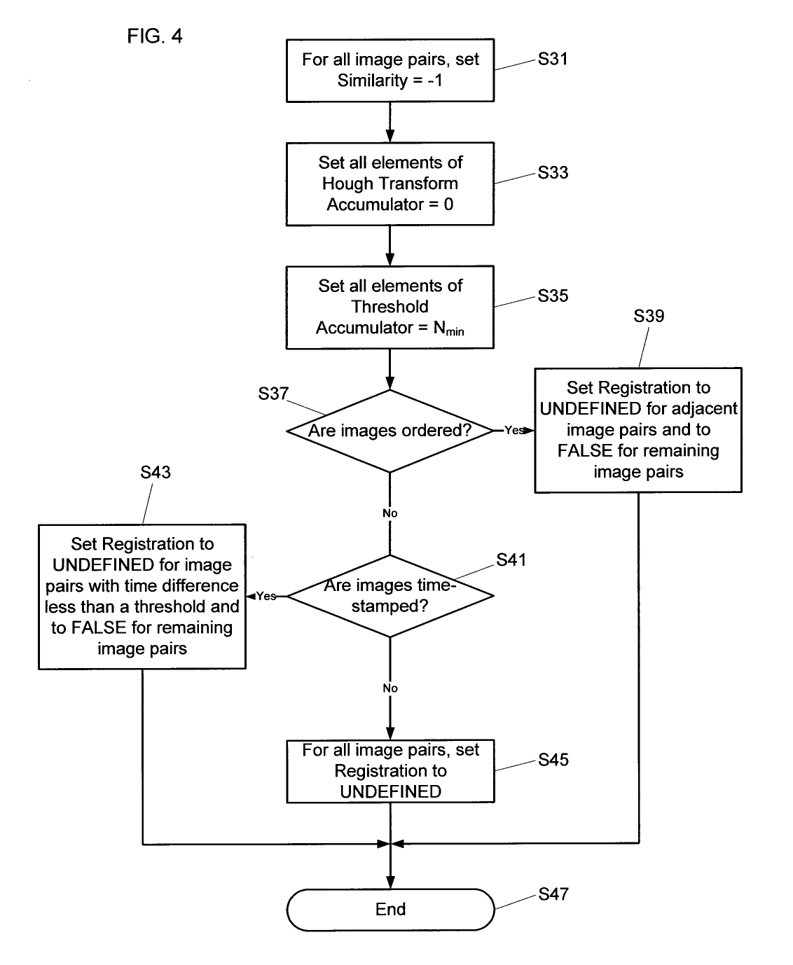

FIG. 4 is a flow chart showing in more detail an initialisation sub-routine which is one of the processing operations illustrated in FIG. 3;

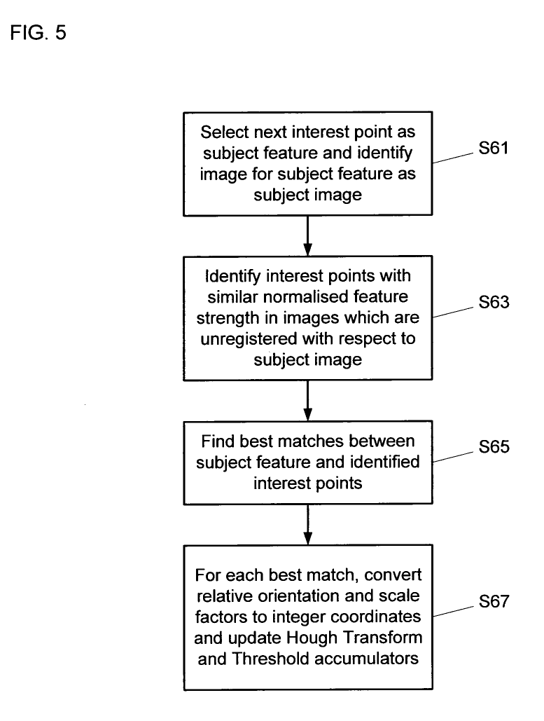

FIG. 5 is a flow chart showing in more detail a feature matching sub-routine which is one of the processing operations performed in FIG. 3;

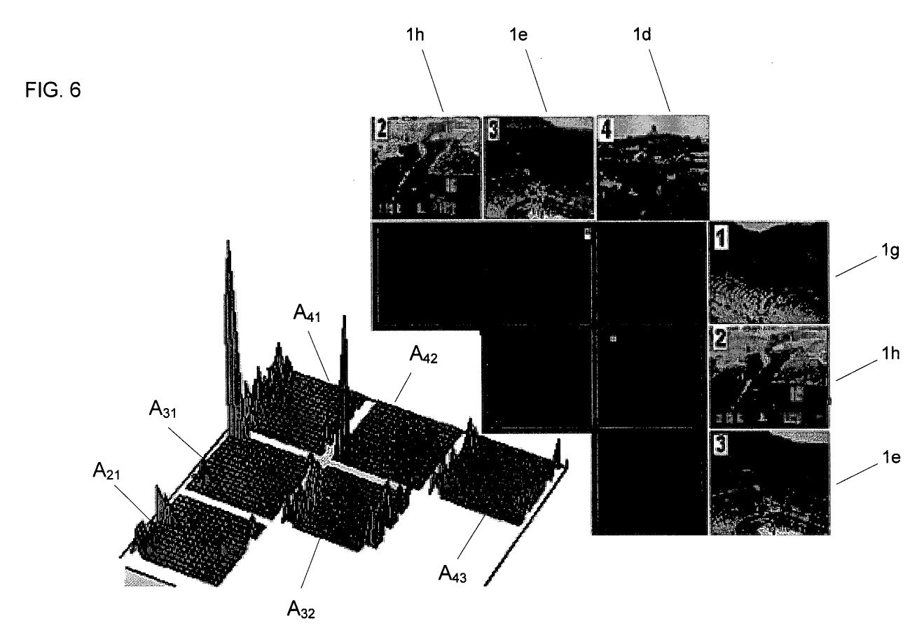

FIG. 6 schematically shows data recorded in a Hough Transform accumulator during image processing for a sample set of images;

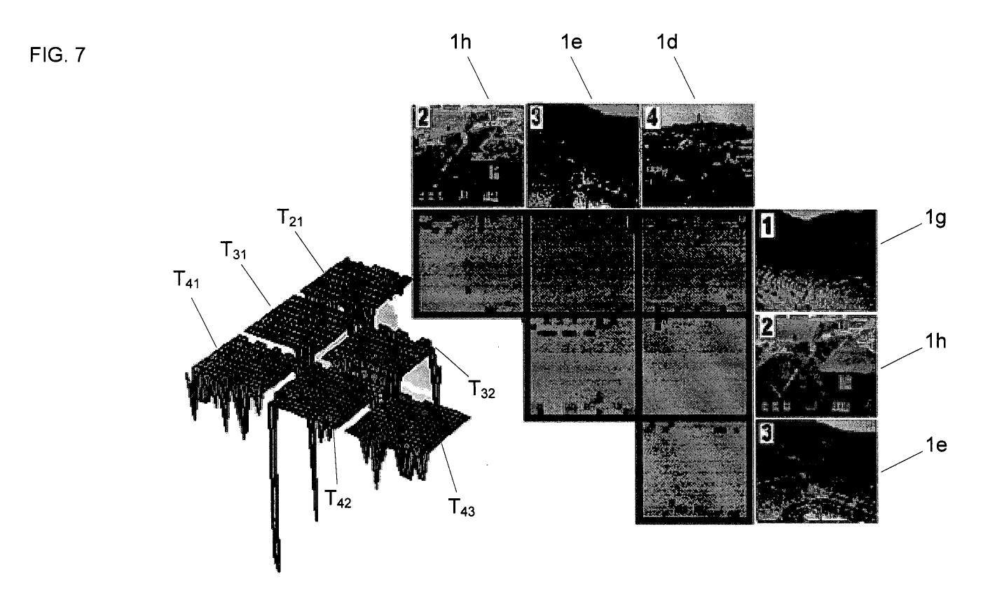

FIG. 7 schematically shows data recorded in a Threshold accumulator during image processing of a sample set of images;

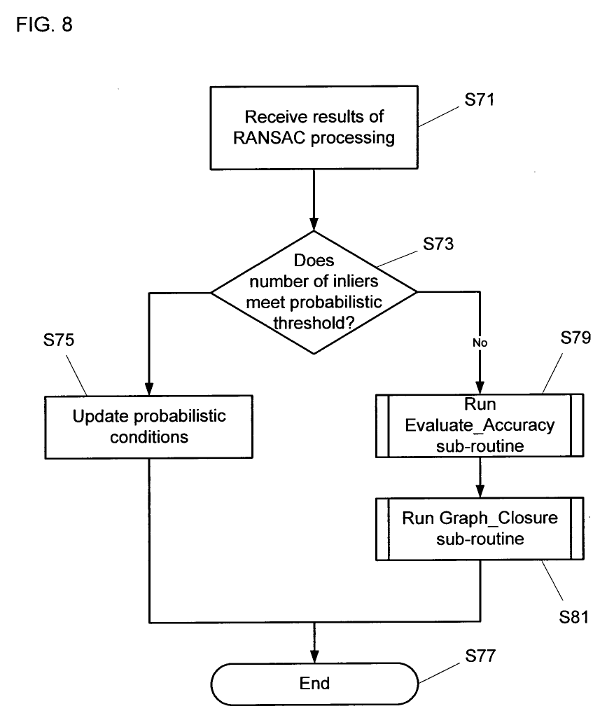

FIG. 8 is a flow chart showing the main operations in a sub-routine for updating a registration graph and/or probabilistic condition which is one of the processing operations performed in FIG. 3;

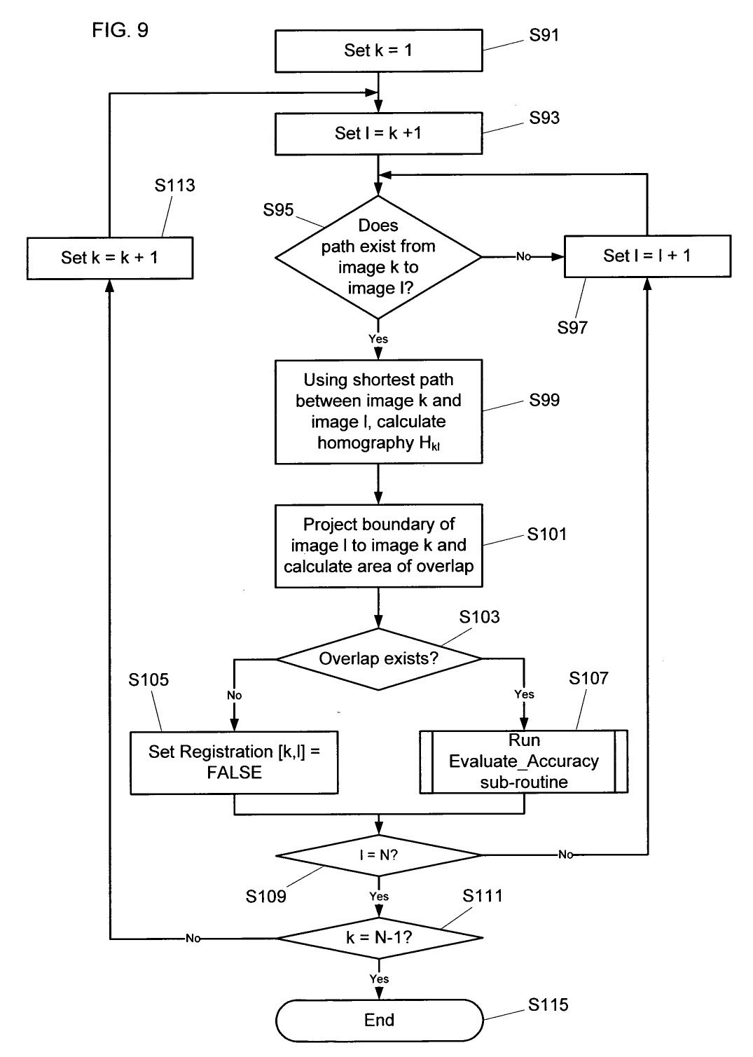

FIG. 9 is a flow chart showing the main operations in a sub-routine for performing transitive registration graph closure which is run as part of the sub-routine illustrated in FIG. 8; and

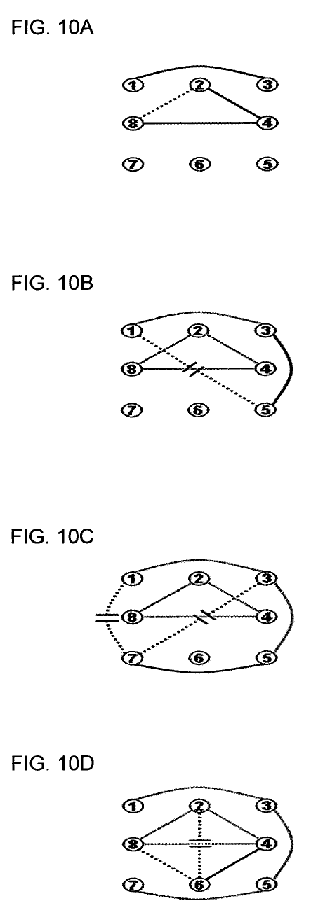

FIGS. 10A to 10D schematically illustrate the development of the registration graph during panorama recognition.

### MAIN EMBODIMENT

As shown in FIG. 1, in this embodiment a plurality of images 1a-1h are input into an image processing module 3. In this exemplary embodiment, the plurality of images 1 are an unordered set of eight images 1, a first group of four of which are pictures of a Roman amphitheatre and a second group of four of which are pictures of a city roofscape.

In a manner which will be described in detail below, the image processing module recognises the groups of images which form panorama views and merges the images in each recognised group together. In this way, a first panorama image 5a is formed of a Roman amphitheatre and a second panorama image 5b is formed of a city roofscape.

FIG. 2 shows the main components of the image processing module 3. In this embodiment, the image processing module 3 forms part of a computing apparatus having a processor 11, input/output interfaces 13 and memory 15 interconnected by a bus system 17.

In this embodiment, the input/output interfaces 13 include a CD-ROM reader/writer (not shown) which allows data to be written to or read from a CD-ROM 19, and a network interface (not shown) which allows data to be input and output in the form of data signals 21.

The processor 11 uses routines stored in the memory 15 to process image data stored in the memory 15 or input by the interfaces 13 to generate panorama data. This panorama data can be stored in the memory 15 and/or output via the interfaces 13.

For ease of illustration, FIG. 2 schematically shows the memory 15 split up into memory regions. As shown, the memory 15 has an images region 23, a features region 25, an accumulators region 27, a registration graph region 29, a working memory region 31 and a routines region 33. It will be appreciated that these memory regions need not correspond to contiguous blocks of memory. In addition, in a conventional manner the memory 15 may include various memory devices having different access times with conventional data caching techniques being employed to reduce processing time.

The images memory region stores N images 35a-35n. Each image 35 comprises a two-dimensional array of image data so that the images 35 may be represented as Iₖ(x,y) for k=1 . . . N.

The features memory region 25 stores feature data for interest points identified in the images 35 stored in the images region 23. These interest points correspond to distinctive features in the images 35 which may be compared to determined if the images contain common features. Each interest point has a corresponding strength value and, as will be discussed in more detail hereafter, in this embodiment interest points with similar strength values are grouped together into bins 37a-37n.

The accumulators memory region stores a Hough transform accumulator 39 and a Threshold accumulator 41. The Hough transform accumulator 39 logs, for each pair of images 35, the relative orientations and scales of features from that pair of images which are judged similar. A cluster of matched features between a pair of images having similar relative orientations and scales is indicative of an overlap between the corresponding images. However, identifying matching features is processing intensive and therefore in this embodiment once a comparatively small number of matches with similar relative orientations and scales is identified, further testing is performed to assess the reliability of the matches. As will be discussed in more detail hereafter, the Threshold accumulator 41 keeps track of how many more potentially reliable matched features with similar relative orientations and scales need to be identified before such further testing is carried out.

The registration graph 29 stores data representative of the determined matching between the images 35 in the images memory region 23. In particular, for each pair of images (k₁,k₂) the registration graph 29 stores a Registration [k₁,k₂] and a Similarity [k₁,k₂] value. The Registration [k₁,k₂] has three possible values: TRUE indicating that Image k₁ has been found to overlap Image k₂; FALSE indicating that Image k₁ has been found not to overlap image k₂; and UNDEFINED indicating that further testing is required. The Similarity [k₁,k₂] value is a number indicative of the quality of similarity between Image k₁ and Image k₂.

The working memory region 31 is used by the processor 11 to store intermediate data during processing operations.

The routines memory region 33 stores the routines which are used by the processor 11 during panorama recognition. In this embodiment, the routines memory region stores:

a Master_Control routine 43 which co-ordinates the panorama recognition process;

an Initialisation sub-routine 45 which initialises the Hough Transform accumulator 39, the Threshold accumulator 41 and the registration graph 29;

a Feature_Matching sub-routine 47 which performs iterative feature matching;

an Update_RG/PC sub-routine 49 which is used to update the registration graph and/or probabilistic conditions used to assess image overlap;

an Evaluate_Accuracy sub-routine 51 which is used to evaluate and improve a homography transformation linking overlapped regions of two images; and

a Graph_Closure sub-routine 53 which is used to perform transitive graph closure each time a new edge is added to the Registration Graph 29.

The main steps in the Master_Control routine 43 are shown in FIG. 3. As shown, following receipt, at S1, of N input images the Master_Control routine 43 calls the Initialisation sub-routine 45.

As shown in FIG. 4, the Initialisation sub-routine 45 sets, at S31, the Similarity value in the Registration graph for each pair of images to −1. The Initialisation sub-routine 45 then sets, at S35, all the elements of the Hough Transform accumulator to 0, and sets, at S37, all the elements of the Threshold accumulator to Nₘᵢₙ, where Nₘᵢₙ is the minimum number of reliable feature matches required to enable confirmation of overlap between two images. The manner in which the value of Nₘᵢₙ is calculated will be discussed in more detail hereafter.

The Initialisation sub-routine 45 then checks, at S37, if the Images include ordering information indicating the order in which the images were recorded. If the images are ordered, then the Initialisation sub-routine 45 sets the Registration data for consecutive images to UNDEFINED and sets the Registration data for all other image pairs to FALSE. This means that, at least initially, overlap between non-consecutive images is not investigated. The Initialisation sub-routine 45 then ends, at S47.

If the images are not ordered, then the Initialisation sub-routine 45 checks, at S41, if the images are time-stamped (i.e. include the time at which the images were recorded). If the images are time-stamped, then the Initialisation sub-routine 45 sets the Registration data for Images which were recorded within a predefined time of each other, for example ten minutes, to UNDEFINED and sets the Registration data for all other image pairs to FALSE. This means that, at least initially, overlap between images which were recorded more than the predefined time apart is not investigated. The initialisation sub-routine 45 then ends, at S47. If the Images 35 are not time-stamped, then the Initialisation sub-routine sets, at S45, the Registration data for all image pairs to UNDEFINED and the Initialisation sub-routine ends, at S47.

Returning to FIG. 3, when the Initialisation sub-routine 45 has ended, the Master_Control routine then detects, at S5, interest points in the Images 35. In this embodiment, a modified version of the Foerstner Operator described in the article “A fast algorithm for detection and precise location of distinct points, corners, and circular features” by Foerstner and Gulch in Proc. Intercommission Conference on Fast Processing of Photogrammetric Data, Interlaken (1987) pp 287-305 (the whole contents of which is hereby incorporated by reference) is used. In particular, the ratio R(x,y) of the determinant and the trace of an autocorrelation matrix A computed in the local neighbourhood n(x,y) of each pixel is calculated as set out in equations (1) and (2) below:

$$\begin{matrix} R ( x , y ) = \frac{det A ( x , y )}{traceA ( x , y )} \\ where \text{:} & ( 1 ) \\ A ( x , y ) = {\sum }_{( {x}^{′} , {y}^{′} ) ∈ n ( x , y )} G ( {x}^{′} , {y}^{′} ) [ \begin{matrix}{I}_{x}^{2} ( {x}^{′} , {y}^{′} ) & {I}_{x} ( {x}^{′} , {y}^{′} ) {I}_{y} ( {x}^{′} , {y}^{′} ) \\ {I}_{x} ( {x}^{′} , {y}^{′} ) {I}_{y} ( {x}^{′} , {y}^{′} ) & {I}_{y}^{2} ( {x}^{′} , {y}^{′} )\end{matrix} ] & ( 2 )\end{matrix}$$

In equation (2), a Gaussian G(x,y) is used to weight the derivatives summed over the window. Interest points are identified by fitting a quadratic to each local maximum in the map of R(x,y). The position of a local maximum corresponds to the position of an interest point, and the estimated value of the local maximum determines the feature strength Rₘ. The detected interest points in each image are sorted in order of decreasing feature strength so that the most prominent interest points are located toward the top of the list. Accordingly, R₁≧R₂≧ . . . ≧Rₘ≧ . . . ≧Rₙ.

After detecting the interest points, the Master_Control routine 43 normalises, at S7, the detected interest points. In this embodiment, normalisation is performed on an image-by-image basis, with the normalised feature strength for each interest point m in an image being given by equation (3) below:

$${r}_{m} = \frac{log {R}_{m} - log {R}_{n}}{log {R}_{1} - log {R}_{n}} \qquad ( 3 )$$

This gives a range of normalised corner strengths varying over the interval 0 to 1. The features from all of the images are then sorted into the bins 37 in accordance with their feature strengths. In particular, in this embodiment each bin 37 corresponds to a distinct percentile of the interval 0 to 1 with bin 1 covering 0.00 to 0.01, bin 2 covering 0.01 to 0.02, and so on until bin 100 covers the range 0.99 to 1.00. Each feature f is indexed by a global index i over all images in order of feature strength, and a feature fᵢ stores the following information:

fᵢ=(xᵢ, yᵢ,mᵢ,kᵢ,dᵢ) (4)

where kᵢ identifies the image in which the feature occurs, mᵢ identifies the index number of the feature in that image, (xᵢ, yᵢ) is the location of the feature in image kᵢ, and dᵢ is a feature descriptor used for comparison purposes. In this embodiment, the feature descriptor dᵢ is formed by a log-polar transformation (LPT) of the pixel values in a local image region centred at the interest point according to:

(x(θ, s), y(θ, s)=(xᵢ,yᵢ)+e^{s}(cos θ, sin θ) (5)

The reason for normalising and sorting the interest points is that generally a feature will have a similar distinctiveness in different images in which the feature appears. The feature strength is not, however, invariant to multiplicative intensity changes. Accordingly, normalisation is performed to remove the multiplicative factor.

After the interest points have been normalised and sorted, the Master_Control routine 43 calls the Feature_Matching sub-routine 47.

As shown in FIG. 5, the Feature_Matching sub-routine 47 selects, at S61, the next interest point to be evaluated, which will be referred to as the subject feature. In this embodiment, the interest points are investigated in order of decreasing feature strength (i.e. the most distinctive features are identified first). Accordingly, the subject feature is the interest point having the highest feature strength which has not already been evaluated.

The Feature_Matching sub-routine 47 then identifies, at S63, features with similar normalised feature strength which appear in other images which are currently unregistered with respect to the image in which the subject feature appears (i.e. for which the Registration data between the two images is UNDEFINED). In particular, in this embodiment only features having a normalised feature strength within 0.15 of the normalised feature strength of the subject feature are investigated. In other words, only those features in bins corresponding to normalised feature strengths within 0.15 of the normalised feature strength of the subject feature are investigated.

Having identified features with similar normalised feature strength in other images which have not yet been registered with the image of the subject feature, the Feature_Matching sub-routine 47 then finds, at S63, the best matches between the subject feature and the identified features. This involves comparing the descriptor dᵢ of the subject feature fᵢ with the descriptors of the identified features. The similarity is characterised by a numerical value ν, local relative orientation θ and scale factor S between image regions.

As discussed previously, the descriptor dᵢ for each interest point is generated using an LPT transformation. In this way, scaling and orientation around the axis is represented by a shift in (θ,s) co-ordinates. Thus, by using a method of 2D matching a similarity value, the local rotation and the scale between image regions centred at interest points is obtained. In this embodiment, a rapid but less reliable 1D matching algorithm is first applied to projections of the log-polar image to filter out non-similar feature pairs, followed by a normalised correlation or phase correlation 2D matching algorithm.

Having found the best matches, the Feature_Matching sub-routine 47 converts, at S67, the orientation and scale parameters into integer co-ordinates and updates the Hough Transform accumulator 39 and the Threshold accumulator 41. As discussed previously, the Hough Transform accumulator 39 keeps track of the number of matches with similar orientation and scale values because true matches between two images usually have similar orientation and scale values, whereas false matches are usually uniformly distributed in the rotation-scale domain. Integer co-ordinates [p,q] are introduced in the (θ,log S) domain as follows:

θ_{q}=2 πp/pₘₐₓ, p=0, . . . , pₘₐₓ₋₁ (6)

s_{q}=s₀+qΔs, q=0, . . . ,qₘₐₓ₋₁ (7)

where s=log S, s₀ is the logarithm of the minimal scale factor and Δs is a discrete step of the log-scale axis.

In this embodiment, a separate Hough Transform accumulator is used for each image pair, so that for N images there are N(N-1)/2 Hough Transform accumulators with the Hough Transform accumulator for matches between interest points in image kᵢ and image kⱼ (where kᵢ>kⱼ) being represented by Aᵢⱼ[p,q]. Each Hough Transform accumulator is a 2D array of integers. For the subject feature, each of the best identified matches is mapped into [p,q]-coordinates and the corresponding [p,q] value in the Hough Transform accumulator linking the image of the subject feature and the image of that best match is increased by 1.

FIG. 6 shows this voting approach applied, for ease of illustration, to just four of the images 1, in particular images 1e and 1g which show overlapping views of the Roman amphitheatre and images 1d and 1h which show overlapping views of the city roofscape. Accumulator A₂₁ is associated with the pair of images 1h and 1g, accumulator A₃₁ is associated with the pair of images 1e and 1g, accumulator A₄₁ is associated with the pair of images 1d and 1g, accumulator A₃₂ is associated with the pair of images 1e and 1h, accumulator A₄₂ is associated with the pair of images 1d and 1h and accumulator A₄₃ is associated with the pair of images 1d and 1e.

In FIG. 6, approximately 10% of the interest points from each image have been processed. Large peaks are present in accumulators A₃₁ and A₄₂ indicating large numbers of matched features with the same [p,q] values. This is expected as these accumulators are associated with pairs of images which overlap. Small noisy peaks in other accumulators show that the correspondent image pairs belong to different sequences and cannot be geometrically aligned.

While the distribution of feature matches in the Hough Transform accumulator is indicative of which images overlap, the number of geometrically consistent matches is a more discriminative indicator of a true cluster than the height of a peak in the Hough Transform accumulator. This is because a peak in the Hough Transform accumulator normally contains a number of false matches, and these false matches should be removed before computing the image transformation in order to reduce error. The false matches can be removed by applying a RANSAC estimator to identify matched feature pairs which are geometrically consistent with homography between the images (referred to as inliers) and matched feature pairs which are geometrically inconsistent (referred to as outliers). In this embodiment, the relative number of inliers and outliers is used when determining whether or not images overlap as will be described in more detail hereafter.

As shown in FIG. 7, in the same manner as for the Hough Transform accumulator 39, the Threshold accumulator 41 includes a 2D accumulator in [p,q] space for each image pair. As discussed previously, all the elements in the Threshold accumulator 41 are initially set to Nₘᵢₙ, and each of the best identified matches is mapped into [p,q]-coordinates and the corresponding [p,q] value in the Threshold accumulator linking the image of the subject feature and the image of that best match is decreased by 1.

Returning to FIG. 3, after performing feature matching for a subject feature, the Master_Control routine 43 checks, at S11, if any elements of the Threshold accumulator 41 have reached zero. If not, then the Master_Control routine 43 performs feature matching for the next image feature. However, if the an element of the Threshold accumulator 41 has reached zero, then the Master_Control routine runs, at S9, RANSAC to identify inliers and the best transformation. In particular, RANSAC processes the feature matches corresponding to the peak in the Hough Transform accumulator 39 to determine a region of overlap and the number of inliers among the interest points in that region of overlap based on an estimated homography. The homography parameters are then re-estimated from all the inliers and then the new more accurate homography parameters are used to find an extended set of inliers using feature matches from neighbouring Hough Transform accumulator elements. This process is repeated until the number of inliers is stable or a fixed number of iterations has been performed.

The Master_Control routine 43 then runs, at S15, the Update_RG/PC sub-routine 49, which analyses the results of the RANSAC processing. The Update_RG/PC sub-routine will now be discussed in more detail with reference to FIG. 8.

After receiving, at S71, the results of the RANSAC processing, the Update_RG/PC sub-routine 49 checks, at S73, if a probabilistic threshold for image matching is satisfied. The probabilistic threshold is based on Bayes rule, which allows the probability of an image match being correct to be determined from the number N₍ᵢ₎ of inliers and the number N₍ₒ₎ of outliers. The total number of inliers is assumed to have a binomial distribution, so that the posterior probability of a correct image match is estimated using Bayes rule as:

$$P ( Correctmatch \vert {N}_{( i )} ) = \frac{P ( {N}_{( i )} \vert Correctmatch ) P ( Correctmatch )}{\begin{matrix}P ( {N}_{( i )} \vert Correctmatch ) P ( Correctmatch ) + \\ P ( {N}_{( i )} \vert Falsematch ) ( 1 - P ( Correctmatch )\end{matrix}} \qquad ( 8 )$$

where P(x|y) is the probability that x is TRUE given y.

Accepting an image match when P(Correct match|N₍ᵢ₎) is greater than Pₘᵢₙ results in the condition:

N₍ᵢ₎>α+β N₍ₒ₎ (9)

where numerical values for α and β are obtained by setting values for the probability that a feature match is an inlier for the correct image match, the probability that a feature match is an outlier for a correct image match, Pₘᵢₙ and P(Correct match). Thus, the Update_RG/PC sub-routine 49 checks if the condition specified in Equation (9) is satisfied.

If the number of inliers does not meet the probabilistic threshold, then the Update_RG/PC sub-routine 49 updates, at S75, the probabilistic conditions and enters a new value in the element [p,q] of the Threshold accumulator 41 being investigated. From equation (9), it can be seen that the minimum number Nₘᵢₙ required to establish an image match occurs when the number of outliers is zero and is given by:

Nₘᵢₙ=[α+1] (10)

where [ . . . ] is the integer part of the real number. Nₘᵢₙ is the initial value entered into the elements of the Threshold accumulator 41 as discussed previously. Accordingly, no further tests are performed until an element of the Threshold accumulator 41 contains the minimum number of features which allows designation of an image match.

If the relationship between the number N₍ᵢ₎ of inliers and the number of outliers N₍ₒ₎ identified in the RANSAC processing does not satisfy equation (9), then the Update_RG/PC sub-routine 49 updates, at S75, the probabilistic condition to be satisfied before RANSAC processing is performed again. This is based on the fact that the minimum number Nₘᵢₙ′ of additional potential feature matches which is required to allow the possibility of designating an image match must satisfy equation (11):

Nₘᵢₙ′+N₍ᵢ₎=α+β N₍ₒ₎ (11)

meaning that:

Nₘᵢₙ′=[α+β N₍ₒ₎−N₍ᵢ₎+1] (12)

The value of the [p,q] element in the Threshold accumulator 41 corresponding to the cluster of feature matches being investigated is then set to Nₘᵢₙ′, so that RANSAC processing of those feature matches is not performed again until the minimum number of additional feature matches has been added to the [p,q] element to make it possible to satisfy equation (9).

It will be appreciated from equation (12) that the larger the number of outliers N₍ₒ₎ then the larger the value of Nₘᵢₙ′. Given this, it is possible for the value of Nₘᵢₙ′ to reach a value for which it is statistically unlikely that equation (9) will ever be satisfied. In particular, an estimate of the speed of growth of each Hough Transform accumulator element [p,q] is given by the ratio between the number of matches in the accumulator A_{(i,j)}[p,q] and the number of features mᵢ processed in the current image so far. Accordingly, the number of features which need to be compared before the next element of the Threshold accumulator T_{(i,j)} reaches zero can be estimated by:

$$Δ {N}_{( i )} = {min}_{p , q} \frac{{T}_{( i , j )} [ p , q ]}{{A}_{( i , j )} [ p , q ]} {m}_{i} \qquad ( 13 )$$

If the number of features left to be processed in an image kᵢ is less than the minimal number determined ΔN_{(i,j)} by equation (13), then it is statistically unlikely that the image pair kᵢ, kⱼ can be registered. Accordingly, when this occurs the Registration [kᵢ,kⱼ] is set to FALSE. This prevents any more features from image kᵢ being compared with features from image kⱼ.

In FIG. 7, about 10% of the features from each image have been processed. Two elements, one in accumulator T₃₁ and the other in accumulator T₄₂, have already reached zero, indicating that image pairs (3,1) and (4,2) are possible matches. Another element, located in accumulator T₃₂, is approaching zero, indicating that the corresponding cluster of feature matches could be processed using RANSAC after the next few iterations. When this element reaches zero, the RANSAC processing will find very few inliers and a large number of outliers, resulting in a large revised threshold value for that element. This is the expected result because images 3 and 2 do not form part of the same panorama.

If the number of inliers identified in the RANSAC processing does satisfy the probabilistic condition defined by equation (9), then the Update_RG/PC sub-routine 49 runs, at S77, the Evaluate_Accuracy sub-routine 51.

The Evaluate_Accuracy sub-routine 51 calculates a Current_Similarity value for the two images kᵢ, kⱼ by performing a correlation analysis of the area of overlap of the two images, and the best homography between images kᵢ and kⱼ. If the calculated Current_Similarity value is greater than the value of Similarity [kᵢ, kⱼ], then the value of Similarity [kᵢ, kⱼ] is set to the calculated Current_Similarity value. If the Current_Similarity value is above a predefined threshold, then the value of Registration [kᵢ, kⱼ] is set to TRUE. This prevents the comparison of any more features from images kᵢ and kⱼ.

Returning to FIG. 8, the Update_RG/PC sub-routine 49 then runs, at S81, the Graph_Closure sub-routine 53. Generally, the Graph_Closure sub-routine 53 checks if the new registration information for images kᵢ and kⱼ can be used to improve the registration information for any other image pairs. This will now be described in more detail with reference to FIG. 9.

As shown in FIG. 9, the Graph_Closure sub-routine iterates between image pairs with at any time image kₖ and k₁ (where 1>k) being investigated. Initially, the value of k is set, at S91, to 1 and the value of 1 is set, at S93, to k+1. The Graph_Closure sub-routine 53 then determines, at S95, if a path exists from image kₖ to image k₁. If a path does not exist, then 1 is set, at S95, to 1+1 and then it is checked again if a path exists. If a path does exist, then the homography Hₖ₁ is calculated based on the shortest path between image kₖ and image k₁.

The shortest path between two images is not necessary the path employing the smallest number of images. Longer paths with more accurate homographies may be preferred to shorter paths with less accurate homographies. In graph theory, the shortest path problem is finding the shortest path between two vertices such that the sum of the weights of constituent edges is minimised. In this embodiment, the weighting (1—Similarity[kᵢ,kⱼ] is applied to the edge bridging image kᵢ and image kⱼ. This weight takes into account the accuracy of the image registration without taking into account the area of overlap or the number of inliers, as neither of these factors is critical for good registration.

After calculating the homography Hₖ₁, the boundary of image 1 is projected onto image k to calculate, at S105, an area of overlap. If no area of overlap exists, then the Graph_Closure sub-routine sets, at S105, Registration [k,l] to FALSE, thereby preventing any more comparison of features in image kₖ with features in image k₁. If there is an area of overlap, then the Graph_Closure sub-routine runs, at S107, the Evaluate_Accuracy sub-routine 51 to optimise and store the best value for the Similarity [k,l] and the Homography [k,l] and, if the value of Similarity [k,l] exceeds the predefined threshold, sets Registration [k,l] to TRUE to prevent further comparison of features in image kₖ with features in image k₁.

The Graph_Closure sub-routine 53 then checks, at S109, if the value of 1 equals N (the total number of images). If not, the value of 1 is increased, at S97, by one and then the existence of a path is checked again. If 1 does equal N, then the Graph_Closure sub-routine 53 checks, at S111, if k equals N-1. If not, then the value of k is increased, at S113, by one and then the value of 1 is set, at S93, to k plus one and the existence of a path is checked again. If k does equal N-1, then the Graph_Closure sub-routine 53 ends, at S115.

FIGS. 10A to 10D illustrate the way in which the registration graph develops. In FIG. 10A around 4% of the features have been processed and image pairs (3,1), (4,2) and (8,4) have been registered (indicated by solid lines between the corresponding nodes of the registration graph). In addition, there is a path between image pair (2,8) via image 4, and based on the transformations between images 8 and 4 and images 4 and 2 an overlap has between images 8 and 2 has been identified.

In FIG. 10B, around 11% of the image features have been processed, and image pair (5,1) has been registered. In addition a path is now present between image pair (5,1) but no overlap has been calculated. In FIG. 10C, about 40% of the features have been processed, and image pair (7,5) has been registered. In addition, paths are now present between images 7 and 1 and images 7 and 3, but no overlap has been calculated. Finally, in FIG. 10D about 42% of the features have been processed, and image pair (6,4) has been registered. In addition, a path is present between image pair (8,6) and overlap has been calculated, and a path is present between image pair (6,2) but no overlap has been calculated.

Returning to FIG. 3, after updating the registration graph and probabilistic conditions, the Master_Control routine 43 checks, at S17, if all image pairs have been processed. If not, feature matching as described above is performed for the next feature and the process iterates until all image pairs have been registered. Once all image pairs have been registered, groups of connected images are identified from the registration graph, and the images in each group are blended together to form an output which is a set of panoramas.

### Modifications and Further Embodiments

In the main embodiment, the present invention is used to form panoramas from an unordered set of images. This can be useful for digital photography, because both professional and amateur users of digital cameras often take multiple shots of the same scene. This may involve, for example, 1) a panoramic sequence of the same scene, 2) multiple trials to find the best composition inside the frame, 3) multiple trials to find the best camera parameters (shutter speed, aperture), 4) images from a burst mode of the digital camera (when images are taken at small time intervals with possible changing of camera parameters), 5) multiple shots focussed on different objects, 6) multiple shots with flash/no flash, 7) multiple shots of different people in the same view. Thus, multiple shots of the same scene have a special meaning to the user, and some further processing may be desirable (e.g. creating a panorama for the panoramic sequence, selection of shot with best composition/exposure, selection of best portrait etc).

The present invention can be used for fast retrieval of all groups of same-view shots. While for panorama generation, image merging may be automatic, it will be appreciated that in other applications a merged image is not the desired result, but rather just the identification of group of images related to the same view. Implementation of the invention in photo-processing software will help the user to automate the otherwise manual work of images requiring further attention. In an embodiment, the photo-processing software may be implemented in a digital camera.

Another application of the present invention is airborne/satellite surveillance. Usually, airborne and satellite surveillance sensors collect images continuously along a route. These images are ordered. The problem occurs in registering images taken from different routes or orbits. Usually, the information on aircraft/satellite position helps to identify overlapping images from different tracks. The present invention can significantly simplify both problems of registration of along-track images and between-track images. The present invention uniformly incorporates into the registration graph the information on natural image ordering along the tracks and on time-based or position-based ordering of the tracks themselves.

A further application of the present invention is in multi-projector displays. Some large multimedia displays can use multiple projectors to visualise different parts of the same scene. The present invention can help to synchronise outputs from projectors by automatic registration of the projected images. Unordered input to the method makes it possible to use different layouts of projectors. This allows flexible positioning of the projectors without precise manual or semi-automatic processing.

In the main embodiment, a modified Foerstner operator is used to identify interest points. It will be appreciated that other algorithms for identifying interest points could be used, for example Moravec or Hannah operators. In the main embodiment, the feature strengths are normalised to a range between 0 and 1 using a logarithmic function. It will be appreciated that other functions could be used, such as (Rₘ−Rₙ)/(R₁−Rₙ). In addition, the feature strength could be scaled to any range, rather than being normalised over the range 0 to 1.

Although a log-polar descriptor dᵢ is used in the main embodiment, other types of descriptor, such as a normalised image patch or a SIFT descriptor, could be used.

The main embodiment primarily uses four techniques to reduce the number of feature matching operations required, namely:
1) Feature matching being limited to features with similar feature strengths;
2) Irrelevant feature pairs being rejected using a probabilistic approach on an iterative basis;
3) Overlapping images are registered using transitive closure of the registration graph on an iterative basis; and
4) Non-overlapping images are rejected using transitive closure of the registration graph.

It will be appreciated that not all four of these schemes need be used to obtain some benefit, although the best results are obtained when they are all used. In alternative embodiments, schemes 1) and 2), or schemes 1) and 3), or schemes 1) and 3) and 4) could be used.

The embodiment described with reference to the drawings comprises computer apparatus and involves processes performed in the computer apparatus. The invention also extends to computer programs, particularly computer programs on or in a carrier, adapted for putting the invention into practice. The program may be in the form of source code, object code, a code intermediate to source code and object code such as in partially compiled form, or in any other form suitable for using in the implementation of the processes according to the invention.

The carrier may be any entity or device capable of carrying the program. For example, the carrier may comprise a storage medium, such as a ROM, for example a CD-ROM or a semiconductor ROM, or a magnetic recording medium, for example a floppy disc or a hard disc, or an optical recording medium. Further, the carrier may be a transmissible carrier such as an electronic or optical signal which may be conveyed via electrical or optical cable or by radio or other means.

The carrier may be an integrated circuit in which the program is embedded, the integrated circuit being adapted for performing, or for use in the performance of, the relevant processes.

Although in the described embodiment the invention is implemented by software, it will be appreciated that alternatively the invention could be implemented by hardware devices or a combination of hardware devices and software.

1. A method of processing a plurality of images to determine one or more groups of images with each group of images forming a panorama, the method comprising:
identifying distinctive features in each image; comparing a distinctive feature in one image with distinctive features in other images to identify possible matching features; and
processing said possible matches to determine said one or more groups of images,
wherein said comparing comprises comparing said distinctive feature in one image with only a subset of the distinctive features in the other images which satisfy one or more predefined criteria.

2. A method according to claim 1, wherein said comparing stops when the minimal number of features taken from said one image satisfies one or more predefined criteria.

3. A method according to claim 1 or 2, further comprising calculating a feature strength for each identified distinctive feature, and wherein said one or more predefined criteria specify a level of similarity of feature strengths which is to be satisfied for said comparison to take place.

4. A method according to claim 3, wherein the calculating of the feature strengths comprises measuring the values of an interest point detection algorithm at local maxima, and for each image scaling the measured values in accordance with the measured values in that image.

5. A method according to claim 4, wherein said scaling comprises calculating the logarithm of each measured value of a local maxima.

6. A method according to claim 5, wherein said scaling comprises normalising the values of the local maxima into a predefined range which is common to all images.

7. A method according to claim 6, wherein the feature strength ^{r}m for a distinctive feature in an image for which the measured value of the local maximum is ^{R}m is given by:
$${r}_{m} = \frac{log {R}_{m} - log {R}_{n}}{log {R}_{1} - log {R}_{n}}$$
where Ri is the measured value for the local maximum for the most distinctive of the identified distinctive features and Rₙ is the measured value of the local maximum for the least distinctive of the identified distinctive features.

8. A method according to claim 4, wherein said interest point detection algorithm employs a modified Foerstner operator.

9. A method according to claim 1, wherein the comparison of two features comprises: comparing image descriptors for a local region centred at each feature to determine orientation and scale parameters; and logging the determined orientation and scale parameters in association with the image pair corresponding to the two features.

10. A method according to claim 9, further comprising analysing compared features for an image pair having identical logged orientation and scale parameters for global consistency when the number of identical logged orientation and scale parameters exceeds a threshold value.

11. A method according to claim 10, further comprising calculating an initial threshold value based on a probabilistic analysis of the smallest number of correct feature matches which allow registration of the image pair.

12. A method according to claim 10 or 11, wherein said global consistency analysis comprises RANSAC processing.

13. A method according to claim 10, further comprising calculating a new threshold value for the number of additional feature matches having said identical logged orientation and scale parameters if the result of the global consistency analysis is negative.

14. A method according to claim 13, further comprising checking if the number of feature matches with identical orientation and scale parameters required to reach the threshold value associated with those orientation and scale parameters is probable on the basis on the total number on possible feature matches remaining and an estimated feature matching rate for each set of orientation and scale parameters, and if the check indicates that reaching a threshold is improbable then rejecting that image pair as a possible image pairing.

15. A method according to claim 10, further comprising updating a registration graph if the results of the global consistency check is positive.

16. A method according to claim 15, wherein said updating comprises performing transitive graph closure.

17. A method according to claim 16, wherein said transitive graph closure comprises:
identifying an additional possible image pairing for a linked group of images; and
determining if the images in the additional image paring overlap based on nomography information from other image pairings in the linked group of images.

18. A method according to claim 17, further comprising registering a possible image pairing following a determination that the images overlap.

19. A method according to claim 17 or 18, further comprising rejecting a possible image pairing following a determination that the images do not overlap.

20. A method according to claim 1, wherein said processing further comprises determining whether or not a pair of images satisfy probabilistic conditions for registration, and wherein said one or more predefined criteria specify that feature comparison does not take place for features which have already been registered.

21. A method according to claim 20, wherein said processing further comprises determining whether or not a pair of images satisfy probabilistic conditions for not being registered, and wherein said one or more predefined criteria specify that feature comparison does not take place for features which have already been determined not to be registered.

22. A method of processing a plurality of images to determine one or more groups of images with each group of images forming a panorama, the method comprising:
i) identifying distinctive features in each image;
ii) comparing a distinctive feature in one image with distinctive features in other images to identify possible matching features;
iii) processing said possible matches to determine if at least one of said other images is in the same group of images as said one image; and
iv) iteratively repeating steps ii) and iii) with new distinctive images, wherein said comparing does not compare the new distinctive feature with distinctive features in other images which have already been determined to be part of the same group of images as said one image.

23. A method according to claim 22, wherein the processing of possible matches is operable additionally to determine if at least one of said other matches is not in the same group of images as said one image, and wherein said comparing does not compare the new distinctive feature with distinctive features in other images which have already been determined not to be part of the same group of images as said one image.

24. An apparatus operable to perform the method of claim 1.

25. An image processing apparatus operable to process a plurality of images to determine one or more groups of images, with each group of images forming a panorama, the image processing apparatus comprising:
means for identifying distinctive features in each image;
means for comparing a distinctive feature in one image with distinctive features in other images to identify possible matching features; and
means for processing said possible matches to determine said one or more groups of images,
wherein said comparing means is operable to compare said distinctive feature in one image with only a subset of the distinctive features in the other images which satisfy one or more predefined criteria.
